(19) United States
(12) Patent Application Publication
(10) Pub. No.: US 2006/0010696 A1
(43) Pub. Date: Jan. 19, 2006

(54) Hand tool with cutting blade having cutting surfaces with wear-enhancing coating thereon

(76) Inventor: James M. Critelli, Fuquay-Varina, NC (US)

Correspondence Address: COATS & BENNETT, PLLC, P O BOX 5, RALEIGH, NC, 27602, US

(21) Appl. No.: 10/894,283

(22) Filed: Jul. 19, 2004

(51) Int. Cl. B27B 21/02

(52) U.S. Cl. 30/506

(57) ABSTRACT

A manually operated cutting tool comprises a frame having a handle portion adapted to engage a user's hand for manual movement of the frame relative to a material to be cut; a blade removably affixed to the frame and moveable along therewith during a cutting operation; the blade having a plurality of cutting surfaces and formed of a base material of a first material having a first toughness and a rigid wear-enhancing outer coating of a second material, different from the first material, external of the cutting surfaces of the base material; the second material having a second toughness more than the first toughness. The frame may be a hacksaw frame or a utility knife frame. The coating may comprises a vapor deposition applied material, such as a physical vapor deposition applied material.

### BACKGROUND OF THE INVENTION

The present invention is directed generally to hand tools, and more particularly to a hand tool with a cutting blade having cutting surfaces with a wear-enhancing coating thereon.

Hand tool cutting devices, such as utility knives and hacksaws, typically use metallic cutting blades with sharp cutting surfaces. During use, these cutting surfaces engage the material to be cut as the tool is manually moved with respect to the material to be cut. Over time, these cutting edges become dull and the user must replace the blade in what is typically a time consuming process. An increase in blade life therefore would increase the hand tool's efficiency by reducing the frequency of blade replacement.

### SUMMARY

The present invention is directed to a manually operated cutting tool, comprising: a frame having a handle portion adapted to engage a user's hand for manual movement of the frame relative to a material to be cut; a blade removably affixed to the frame and moveable along therewith during a cutting operation; the blade having a plurality of cutting surfaces and formed of a base material of a first material having a first toughness and a rigid wear-enhancing outer coating of a second material, different from the first material, external of the cutting surfaces of the base material; the second material having a second toughness more than the first toughness. The frame may be a hacksaw frame or a utility knife frame. The coating second material of the coating may comprises tungsten. Alternatively, the second material of the coating may comprise zirconium or boron carbide. Further still, the second material of the coating may comprise titanium, such as for example comprising at least one alloy material selected from the group consisting of titanium nitride, titanium cabronitride, aluminum titanium nitride, titanium aluminum nitride, titanium carbide, and titanium nickel. The coating may comprises a vapor deposition applied material, such as a physical vapor deposition applied material.

### BRIEF DESCRIPTION OF THE DRAWINGS

FIG. 1 shows a hand operated cutting tool constructed in accordance with one embodiment of the present invention.

FIG. 2 shows the cutting blade of FIG. 1.

FIG. 3 shows a cross-section of the blade of FIG. 2 along line 3-3.

FIG. 4 shows a hand operated cutting tool constructed in accordance with another embodiment of the present invention.

### DETAILED DESCRIPTION OF THE INVENTION

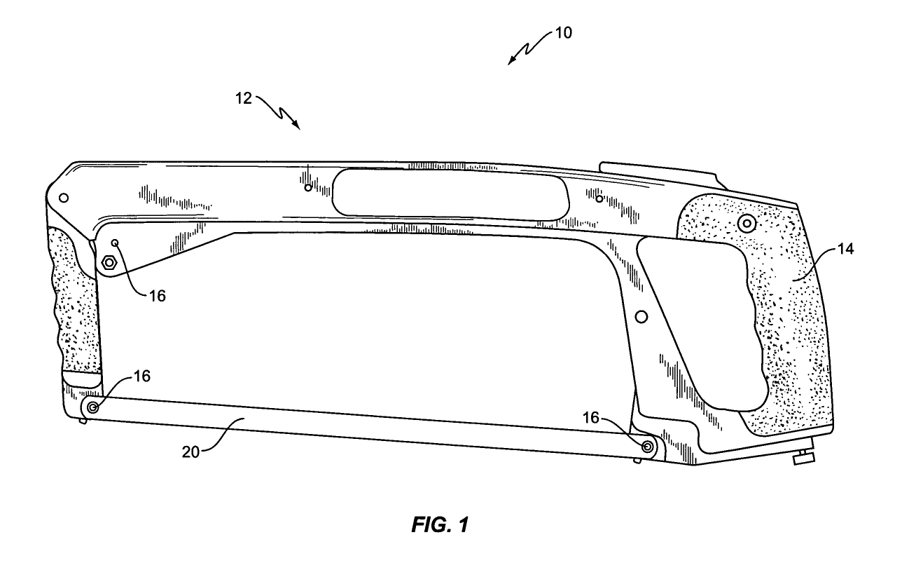

As illustrated in FIG. 1, a hand operated cutting tool, generally designated 10, is shown constructed according to the present invention. As is customary, the tool 10 includes a frame 12 and a cutting blade 20 removably attached thereto. The frame 12 includes a handle 14 for gripping by a user. For the hacksaw type tool shown in FIG. 1, the frame 12 advantageously also includes two blade mounts 16, one toward each end of the frame. For further details of the frame 12, attention is directed to co-pending U.S. patent application Ser. No. 10/845,047, filed May 13, 2004, the disclosure of which is incorporated herein by reference.

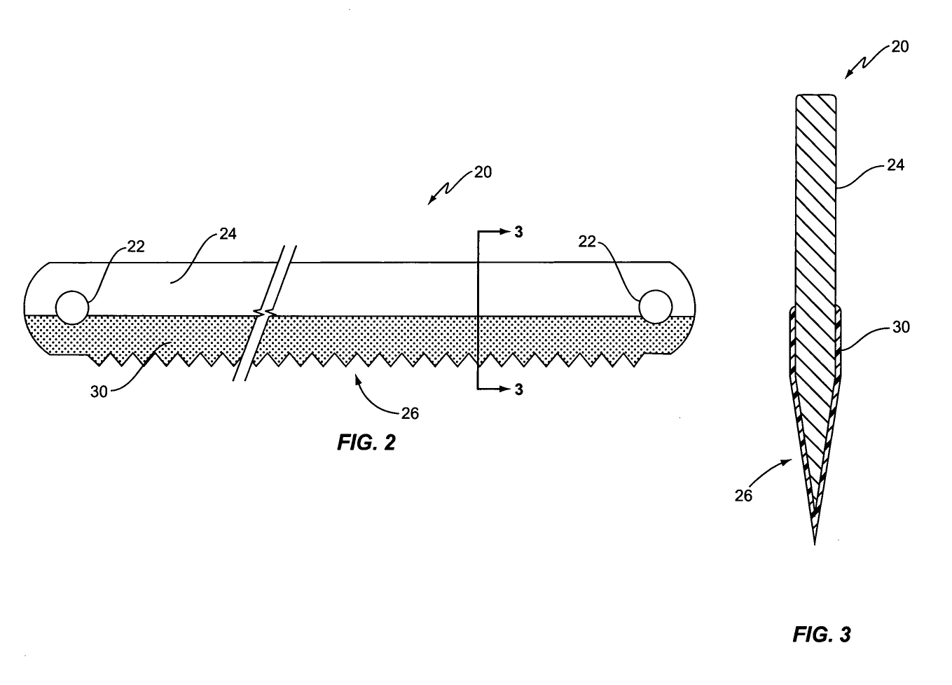

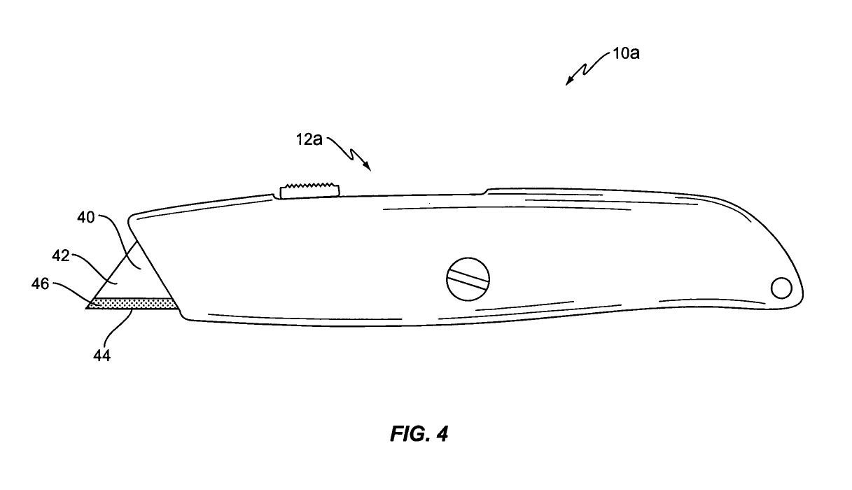

The blade 20 of FIG. 1 is generally elongate, as shown in FIG. 2. The blade includes two spaced mounting holes 22 for engaging with the blade mounts 16 as described in the above-reference application. The blade 20 includes a metallic base 24 or substrate that includes a plurality of cutting surfaces 26, as is known in the art. For the present invention, the cutting surfaces 26 are coated with a tough, rigid coating 30 of a material different from the material of the base 24 so as to increase the wear resistance of the blade 20. For example, the base material may be a conventional hardened steel material, while the coating 30 is a titanium nitride material applied by a physical vapor deposition process. As indicated above, the purpose of the coating is to increase the wear resistance of the cutting surfaces 26. Thus, the material of the coating 30 has a material toughness that is greater than the material toughness of the material of the base 24. Therefore, as used herein, the term “wear-enhancing coating” does not include paint as paint is not considered to have high toughness. By adding the rigid coating 30, the useful life of the blade 20 is significantly increased, such as by two to seven times as much or more.

The wear-enhancing coating 30 may advantageously comprise titanium. Further, the titanium containing wear-enhancing coating 30 may advantageously comprise at least one alloy material selected from the group consisting of titanium nitride, titanium cabronitride, aluminum titanium nitride, titanium aluminum nitride, titanium carbide, and titanium nickel. The coating may be a single layer, or may comprise multiple layers. The wear-enhancing coating 30 may alternatively comprise zirconium nitride, boron carbide, chromium nitride, tungsten, tungsten disulfide.

The coating 30 may advantageously be applied to the cutting surfaces by a vapor deposition process, such as the processes known as physical vapor deposition, plasma deposition, chemical vapor deposition. Just by way of example, suitable coatings may be applied to the cutting surfaces of the blades by a physical vapor deposition process by a company known as Bodycote Metallurgical Coatings, having an office in Greensboro, N.C. Alternatively, but believed to be less advantageous, the coating 30 may be applied by a dipping, sputtering, or other known coating process. It is believed advantageous if the coating 30 is applied after the formation of the cutting surfaces on the base material.

In another embodiment, the hand operated cutting tool may take the form of a tool 10a commonly referred to as a utility knife. See FIG. 3. Such tools 10a typically utilize a trapezoidal shaped cutting blade 40 with the razor type cutting surfaces 44 disposed along the long edge of the trapezoid. The cutting surfaces 44 of the blade's substrate 42 are coated with wear-enhancing coating 46 as described above. Such blades 40 typically also include one or more notches (not shown) in the opposing edge for engaging with retaining means for removably mating the blade to the frame 12a. Advantageously, the retaining means is associated with a moveable blade carriage (not shown) within the tool 10a. Additional details concerning such tools, but with uncoated blades, are shown in U.S. Pat. Nos. 6,553,674; 6,446,340; 6,357,120; and U.S. patent application Publication US 2004/0107580, which are all incorporated herein by reference.

The present invention may, of course, be carried out in other specific ways than those herein set forth without departing from the essential characteristics of the invention. The present embodiments are, therefore, to be considered in all respects as illustrative and not restrictive, and all changes coming within the meaning and equivalency range of the appended claims are intended to be embraced therein.

What is claimed is:

1. A manually operated cutting tool, comprising:
a frame having a handle portion adapted to engage a user's hand for manual movement of the frame relative to a material to be cut;
a blade removably affixed to said frame and moveable along therewith during a cutting operation;
said blade having a plurality of cutting surfaces and formed of a base material of a first material having a first toughness and a rigid wear-enhancing coating of a second material forming the outermost layer of said cutting surfaces; said second material different from said first material and having a second toughness more than said first toughness.

2. The tool of claim 1 wherein said frame comprises a hacksaw frame.

3. The tool of claim 1 wherein said second material of said coating comprises tungsten.

4. The tool of claim 1 wherein said second material of said coating comprises zirconium.

5. The tool of claim 1 wherein said second material of said coating comprises titanium.

6. The tool of claim 5 wherein said second material of said coating comprises at least one alloy material selected from the group consisting of titanium nitride, titanium cabronitride, aluminum titanium nitride, titanium aluminum nitride, titanium carbide, and titanium nickel.

7. The tool of claim 1 wherein said second material of said coating comprises a vapor deposition applied material.

8. The tool of claim 7 wherein said vapor deposition applied material comprises a physical vapor deposition applied material.

9. The tool of claim 1 wherein said frame comprises a utility knife frame.

10. The tool of claim 1 wherein said coating comprises boron carbide.
